(19) United States
(12) Patent Application Publication
(10) Pub. No.: US 2004/0177464 A1
(43) Pub. Date: Sep. 16, 2004

(54) Vehicle windshield wiper and brush assembly

(76) Inventors: Sean Steffee, Overland Park, KS (US); Laurie E. Steffee, Overland Park, KS (US)

Correspondence Address: HOVEY WILLIAMS LLP, 2405 Grand, Suite 400, Kansas City, MO, 64108, US

(21) Appl. No.: 10/387,616

(22) Filed: Mar. 13, 2003

(51) Int. Cl. B60S 1/28

(52) U.S. Cl. 15/250.41; 15/250.4; 15/250.44

(57) ABSTRACT

A windshield wiper assembly (20) is provided comprising a resilient wiper element (36) and a brush element (38). The wiper element (36) and brush element (38) are attached to the corresponding wiper lever (32) and wiper superstructure (30) through a plurality of mounting brackets (34). Mounting brackets (34) are equipped with a plurality of claws 56 which engage and secure the wiper and brush elements (36, 38). Mounting brackets (80) may also be configured to attach a cartridge (82) having wiper and brush elements (36, 38) secured thereto with the corresponding wiper lever (32) and wiper superstructure (30).

### BACKGROUND OF THE INVENTION

1. Field of the Invention

The present invention is broadly concerned with a vehicle windshield wiper assembly which employs the combination of a densely-bristled brush to remove debris which ordinary rubber wiper elements cannot, in conjunction with two outboard wiper elements which are secured to the assembly using an aerodynamic wiper bracket.

2. Description of the Prior Art

Removal of windshield debris has long been a problem encountered by motorists and especially truck drivers and RV owners. The build up of insect splatters, mud, and other tenacious road materials that usually are of oily character has typically required the driver to periodically stop and scrub the windshield. Such stop times not only inconvenience the driver, but are especially problematic with freight hauling trucks drivers, adding significant time delays in reaching their destination.

Most conventional windshield wipers generally employ a single rubber wiper element and function primarily to clean water off of the windshield. The wiper provides little assistance in removal of debris from the windshield surface which may accumulate because of splattered insects, dirt, and various other road materials thrown up behind a moving vehicle. Some windshield wiper assemblies have been devised which utilize multiple rubber wiper elements in order to improve the cleaning power of the wiper assembly, however, these assemblies do not provide much additional assistance in removing the most stubborn debris.

Attempts have been made to provide additional scrubbing power to windshield wipers, primarily through the use of a brush. U.S. Pat. No. 4,339,839 discloses a windshield wiper assembly including a blade carrier which includes a pair of wiper lips and a brush. However, this wiper assembly presents essentially solid front and rear faces (surfaces perpendicular to the windshield) and does not provide any means for air flow through the wiper assembly. Such a disruption in air flow may cause the wiper lips and brush to skip when in use, especially when the vehicle is traveling at highway speeds. Skipping of the lips and brush reduces the efficacy of the assembly in removing fluid and debris from the windshield.

WO 00/09371 discloses a wiper assembly comprising two conventional wiper blades and a motorized brush assembly positioned therebetween. The brush assembly includes an endless belt forming a brushing means which is powered by a motor contained within the brush assembly and is selectively activated by the driver. Because the brush is attached to a flexible, endless belt, the bristle density which can be accommodated on the belt is limited. A less dense brush is not as effective in removing stubborn debris, such as splattered insects, from the windshield. Furthermore, the inclusion of an electric motor greatly increases the overall cost and complexity of the windshield wiper assembly.

Therefore, there exists a real need for a windshield wiper and brush assembly which enables removal of stubborn debris from a windshield while the vehicle is in operation and provides for improved air flow around the wiper assembly so that the wiper and brush elements remain in contact with the windshield surface and avoid skipping, especially when the vehicle is moving at highway speeds.

### SUMMARY OF THE INVENTION

The present invention overcomes the problems noted above and provides a windshield wiper capable of removing stubborn debris from the surface of the windshield in an efficient and cost effective manner. Generally, a windshield wiper according to the invention comprises at least one resilient wiper element adapted for clearing a fluid from the surface of a windshield and a brush element spaced from and parallel with the wiper element. A mounting bracket is provided for securing the wiper and brush elements to the wiper assembly. The mounting bracket presents top and bottom surfaces, the top surface having an orifice is formed therein for attaching the bracket to a windshield wiper lever or superstructure. Attachment of the bracket to a lever or superstructure is made by inserting an end of the lever or superstructure into the orifice and securing the lever or superstructure end using a pin located within the orifice.

Preferably, the wiper and brush elements are attached to the mounting bracket through a plurality of claws which extend outwardly from the bottom surface of the bracket and form a channel through which the wiper and brush elements are slidably received. However, it is within the scope of the present invention for the wiper and brush elements to be contained within a cartridge which is then attached to the mounting bracket. The cartridge presents top and bottom surfaces and includes a plurality of slots formed therein which extend from the cartridge top surface through the cartridge bottom surface. In this alternate embodiment, the mounting bracket claws are replaced with a plurality of flanges which extend outwardly from the bracket bottom surface and are adapted for placement into the cartridge slots for coupling the cartridge with the bracket.

Regardless of which mounting bracket configuration is used, it is preferable that the wiper assembly comprise two substantially parallel wiper elements and one brush element positioned therebetween. The wiper elements are preferably made of rubber, however any suitable, non-abrasive natural or synthetic resin material maybe employed. Preferable brush elements for use with the invention comprise a spine having bristles attached thereto. The spine may be formed of a semi-rigid metal or synthetic resin material, and the bristles may be formed from a material selected from the group consisting of horsehair, hog bristle, synthetic resin materials, and combinations thereof. Preferred synthetic resin materials for bristles include nylon, polypropylene, polyester, PVC, teflon and combinations thereof. It is desirable for the bristles to be densely packed on the brush spine. Preferably, the brush will have a bristle density of about 100-200 bristles/mm², and more preferably of about 50-100 bristles/mm² in order to provide the most cleaning power for removing stubborn debris from the windshield surface. Care should be taken in selecting an appropriate bristle stiffness so that the bristle does not scratch the windshield. Preferably the individual bristles will have diameters between about 0.0015-0.01 inch and exhibit a dry modulus of between about 500-5,000 N/mm² and more preferably from about 1,000-4,000 N/mm².

### BRIEF DESCRIPTION OF THE DRAWINGS

FIG. 1 is a preferred windshield wiper assembly according to the invention.

FIG. 2 is a shortened version of the wiper assembly shown in FIG. 1.

FIG. 3 is an exploded view of the wiper assembly shown in FIG. 1.

FIG. 4 is a cut-away view of the underside of a portion of the wiper assembly from FIG. 3.

FIG. 5 is a top view of the wiper assembly depicting an exemplary wiper fluid spray pattern.

FIG. 6 is a side elevational view of the wiper assembly of FIG. 1.

FIG. 7 is an end view of the wiper assembly of FIG. 6 taken along line 7-7.

FIG. 8 is an end view of the wiper assembly of FIG. 1 shown in operation and in contact with a windshield.

FIG. 9 is a cut-away view of the underside portion of another preferred embodiment of the wiper assembly.

FIG. 10 is an end view of the wiper assembly of FIG. 9.

FIG. 11 is another preferred windshield wiper assembly according to the invention depicting an alternate method of attaching the wiper and brush elements to the mounting bracket.

FIG. 12 is an exploded view of a portion of the wiper assembly of FIG. 11.

FIG. 13 is a view of the underside of a portion of the wiper assembly of FIG. 11.

FIG. 14 is an end view of the wiper assembly of FIG. 11.

FIG. 15 is a cross-sectional view of the wiper assembly of FIG. 14 taken along line 15-15.

### DETAILED DESCRIPTION OF THE PREFERRED EMBODIMENT

The following description sets forth preferred windshield wiper assemblies according to the invention. It is to be understood, however, that these embodiments are provided by way of illustration and nothing therein should be taken as a limitation upon the overall scope of the invention.

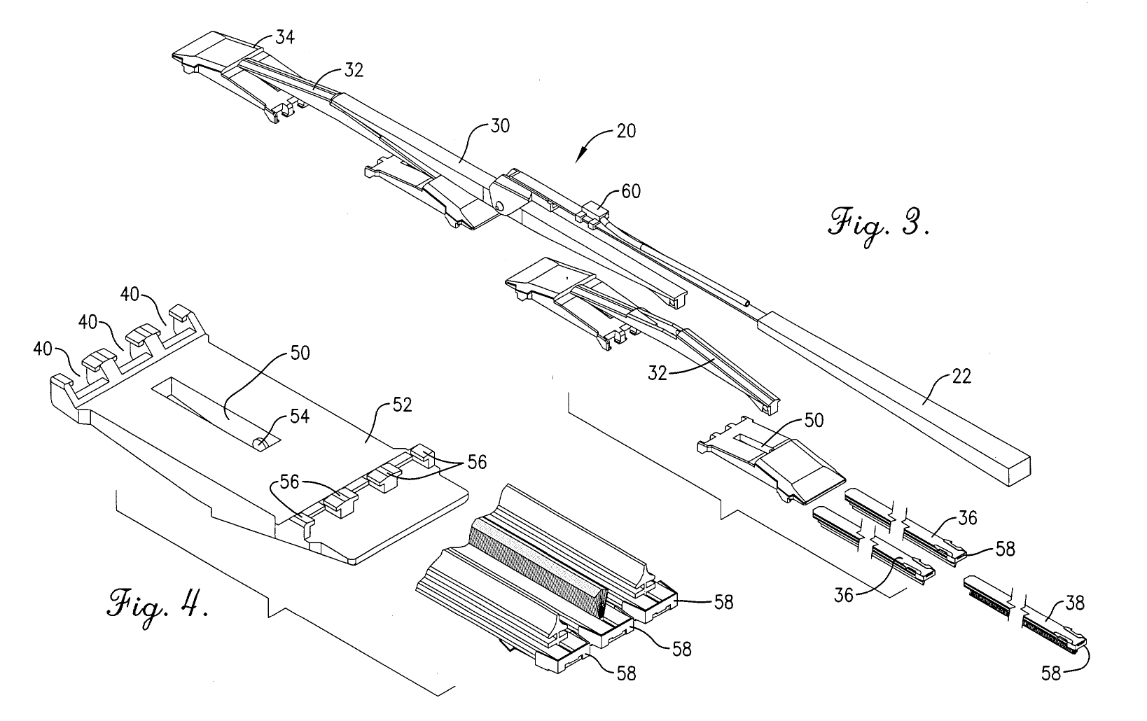

Turning now to the drawings and in particularly to FIG. 1 which depicts a windshield wiper assembly 20 comprising a wiper arm 22 and a wiper blade 24. Wiper blade 24 and arm 22 are pivotally coupled by connector 26 and pin 28. Wiper blade 24 is comprised of a superstructure 30 having levers 32 operably coupled thereto and mounting brackets 34 pivotally coupled with levers 32. Rubber elements 36 and brush element 38 (see FIGS. 3 and 4) are slidably received and secured within channels 40 formed in bracket 34.

The embodiment of the invention shown in FIG. 1 comprises four mounting brackets 34, each coupled with respective ends of levers 32. Brackets 34 are preferably of unitary construction and are interchangeable thereby enabling any particular bracket 34 to be attached to any given lever end. Brackets 34 are aerodynamically shaped and provide improved airflow around wiper assembly 20 so that rubber elements 36 and brush element 38 remain in contact with the windshield during operation while the vehicle is traveling at high rates of speed. Brackets 34 present a sufficient width, so that when elements 36, 38 are received therein, bracket 34 is in covering relationship thereto along substantially the entire length of the bracket.

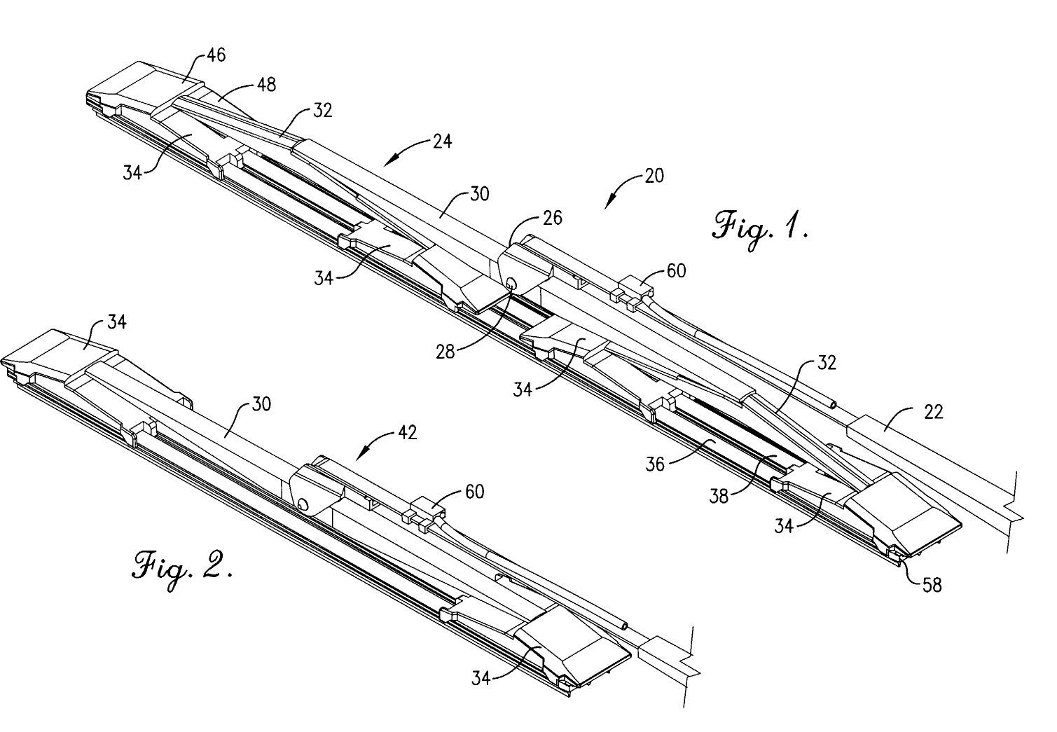

FIG. 2 depicts an alternate preferred embodiment of the invention, namely a wiper assembly 42 comprised of a superstructure 44 having opposed ends, each end operatively coupled with a mounting bracket 34. As opposed to the embodiment of FIG. 1, the embodiment of FIG. 2 does not employ levers to couple superstructure 44 to brackets 34. The embodiment of FIG. 2 is particularly useful in applications calling for short-length wipers, such as on small windows or headlights.

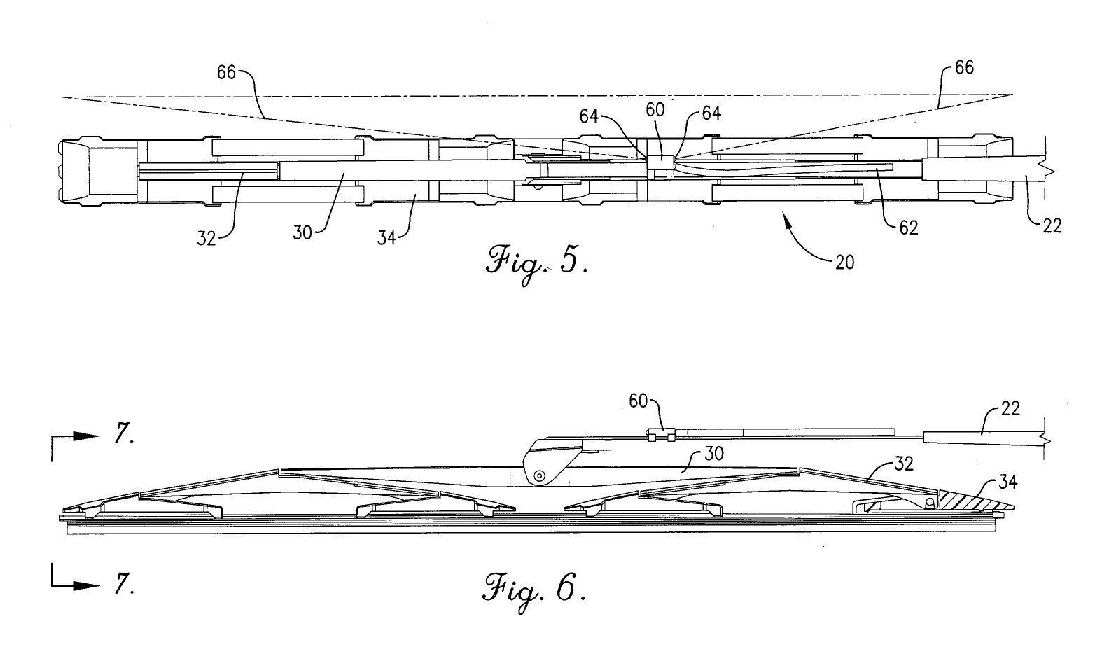

As noted above, brackets 34 are aerodynamically shaped and provide improved airflow proximate wiper assembly 20. As shown in FIG. 6, brackets 34 are generally triangular in side elevation configuration (along the plane perpendicular to the windshield, but parallel to rubber elements 36). Brackets 34 present a top surface generally comprised of sections 46, 48; section 46 presenting a steeper incline than section 48. As shown in FIGS. 3 and 4, orifice 50 is formed in bracket 34 and extends from section 48 through bottom surface 52 of the bracket. Positioned within orifice 50 are pins 54 which provide means for connecting either levers 32 or superstructure 30 with bracket 34. Claws 56 extend outwardly from bottom surface 52 and define channels 40 (described above) through which rubber elements 36 and brush element 38 are slidably received. The innermost claws 56 are generally “T” shaped, while the outer most claws 56 are generally “L” shaped. Rubber elements 36 and brush element 38 are secured to brackets 34 by end clips 58.

FIG. 5 depicts a preferred washer fluid spray pattern for use with the present invention. Washer fluid is fed from the fluid reservoir (not shown) to fluid nozzle 60 via tube 62 which is preferably made from a resilient, but flexible material such as polypropylene. Fluid nozzle 60 comprises at least one, and preferably two fluid jets 64 positioned opposite each other for dispersing fluid sprays 66 on to the windshield. It is preferable for fluid to be sprayed along substantially the entire length of wiper assembly 20 for optimal cleaning effect.

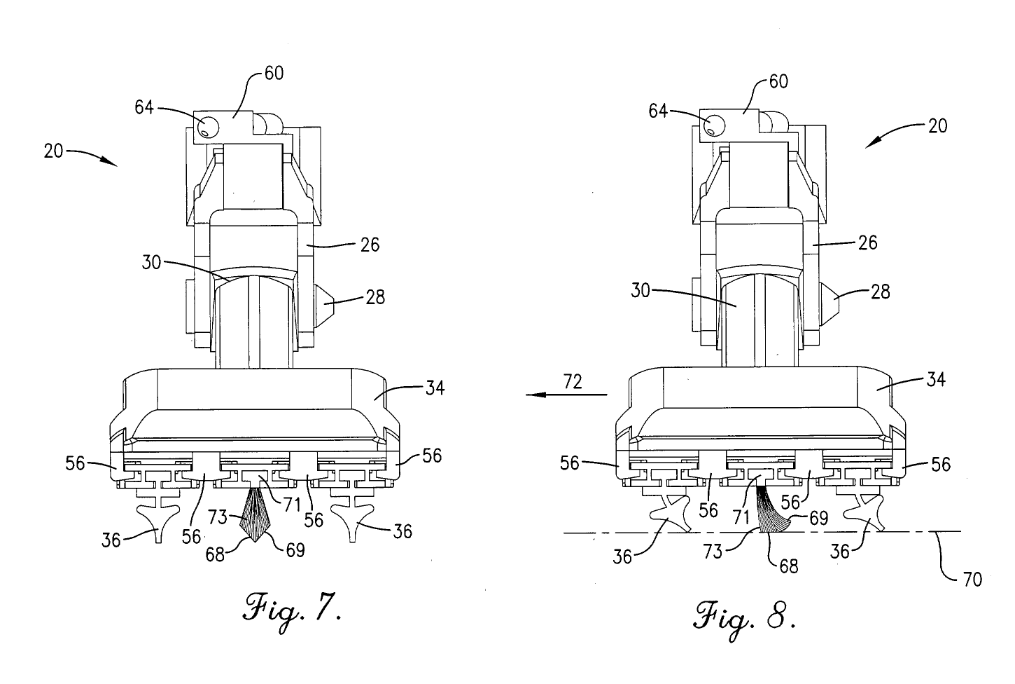

FIGS. 7 and 8 are both end views of wiper assembly 20 taken along line 7-7 of FIG. 6. FIG. 7 shows a stationary wiper assembly 20 and claws 56 securing rubber elements 36 and brush element 38. Brush element 38 is preferably configured to have tapered leading and trailing edges 68, 69 respectively. As shown in FIG. 8, when wiper assembly 20 is in motion and in contact with windshield 70 rubber elements 36 and brush element 38 flex away from the direction of wiper assembly motion (depicted by arrow 72). The flexing of elements 36 brings leading edge 68 into contact with windshield 70. The bristles comprising leading edge 68 contact windshield 70 in substantially perpendicular fashion. This particular contacting arrangement places the greatest number of bristle ends in contact with windshield 70 during operation of wiper assembly 20 thereby resulting in the most effective scrubbing of windshield 70.

Brush element 38 is comprised of a spine 71 having bristles 73 attached thereto. In order to provide effective cleaning, brush element 38 presents a relatively high bristle density. The bristles 73 may be formed of any suitable material having an acceptable degree of stiffness. Overly stiff bristles may not flex properly when in use leading to reduced cleaning power. Preferred bristle materials include horsehair, hog bristle and synthetic resin materials such as nylon, polypropylene, polyester, PVC, teflon and combinations thereof.

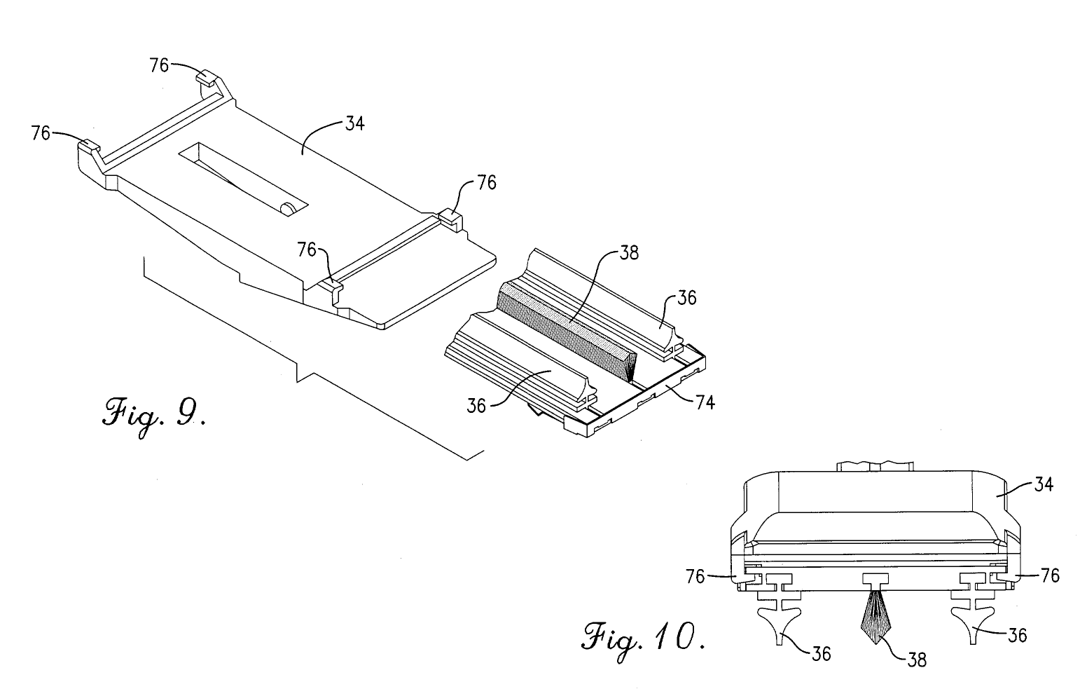

As shown in FIG. 3, rubber elements 36 and brush element 38 comprise members which may be individually removed from brackets 34 and replaced as needed. Alternatively, as shown in FIGS. 9 and 10, rubber elements 36 and brush element 38 may be coupled together by a single end clip 74. Rubber elements 36 are slidably received by bracket 34 and secured by claws 76. Bracket 34 shown in FIG. 9 differs from the bracket shown in FIG. 4 in that the innermost claws from the FIG. 4 bracket have been removed, thereby leaving only the outermost, L-shaped claws to secure the rubber and brush elements 36, 38. Construction as shown in FIG. 9 allows rubber elements 36 and brush element 38 to be replaced simultaneously in one step.

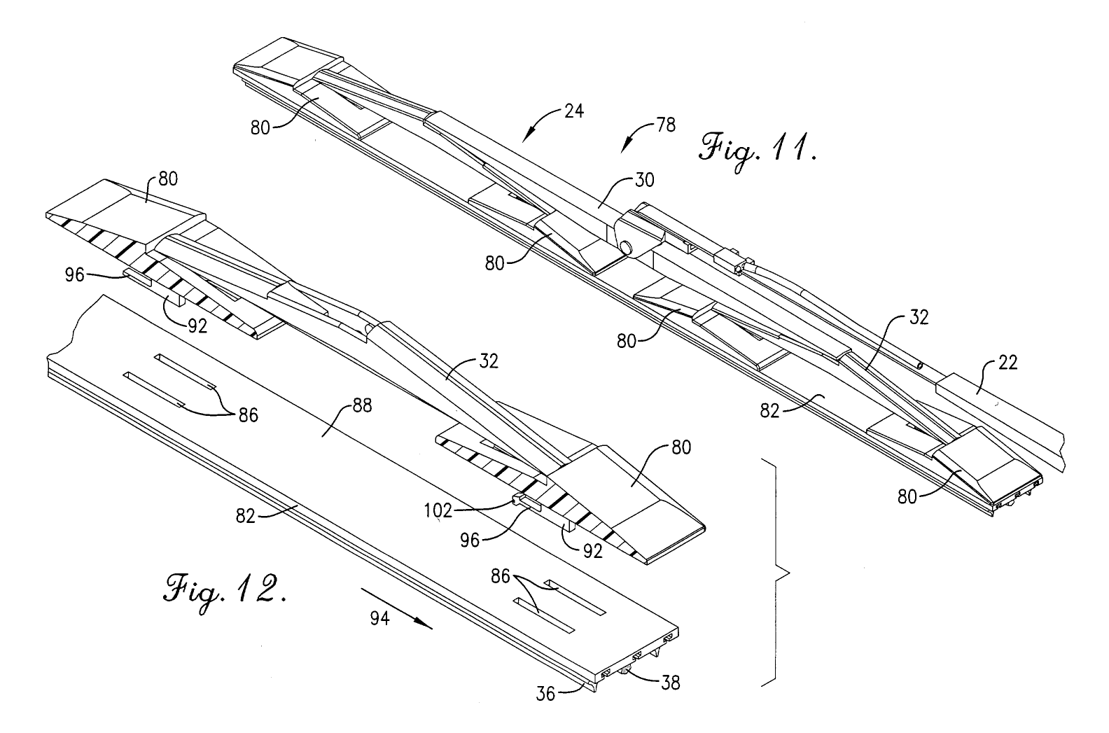

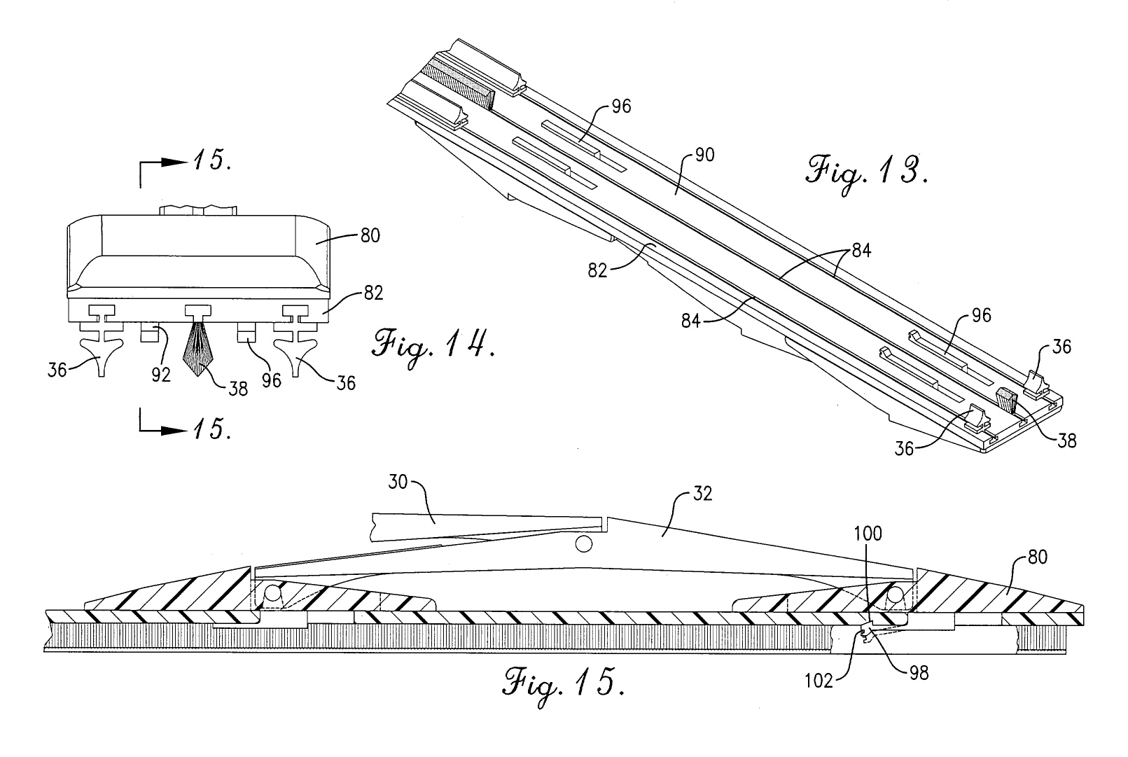

FIGS. 11-15 depict yet another embodiment of the present invention which allows for quick and easy replacement of rubber and brush elements 36, 38. Like the embodiment depicted in FIG. 1, wiper assembly 78 comprises a wiper arm 22 and a wiper blade 24. Wiper blade 24 is comprised of a superstructure 30 having levers 32 operably coupled thereto. Wiper blade 24 comprises mounting brackets 80 which present top surfaces having a very similar overall appearance to mounting brackets 34 shown in FIG. 1. However, unlike mounting brackets 34, rubber elements 36 and brush element 38 are not received or secured directly by brackets 80. Instead, rubber elements 36 and brush element 38 are received by cartridge 82. As shown in FIGS. 13 and 14, cartridge 82 includes three channels 84 formed therein which secure rubber and brush elements 36, 38.

Cartridge 82 comprises a plurality of slots 86 formed therein which extend from cartridge top surface 88 through cartridge bottom surface 90. Slots 86 are designed to receive flanges 92 which extend downwardly from brackets 80. Flanges 92 present a general L-shape configuration which, when received in slot 86, secures cartridge 82. As shown in FIG. 12, cartridge 82 is positioned below lever 32 and brackets 80. Flanges 92 are inserted into slots 86, and then cartridge 82 is shifted in the direction of arrow 94 so that arm 96 engages cartridge bottom surface 90. As shown in FIG. 15, at least one flange 92 is equipped with a head 98 which is capable of being received into recess 100 formed in bottom surface 90. Head 98 and recess 100 cooperate to lock cartridge 82 in place while the wiper assembly is in operation. Head 98 is formed with a notch 102 so that head 98 can be separated from recess 100 (shown in phantom) using a fingernail, or flathead screwdriver, and cartridge 82 released from bracket 80.

We claim:

1. A windshield wiper comprising:
a resilient wiper element adapted for clearing a fluid from the surface of a windshield;
a brush element spaced from said wiper element and substantially parallel therewith;
a mounting bracket presenting top and bottom surfaces, said top surface comprising first and second sloping sections, the slope of said first section being greater than the slope of said second section, said second section presenting an orifice formed therein for attaching said bracket to either a windshield wiper lever or superstructure; and
a plurality of claws extending outwardly from said bottom surface cooperatively forming a plurality of channels through which said wiper and brush elements are slidably received.

2. The wiper of claim 1, said resilient wiper element being comprised of rubber.

3. The wiper of claim 1, said brush element comprising a spine having bristles attached thereto.

4. The wiper of claim 3, said bristles comprising a material selected from the group consisting of horsehair, hog bristle, synthetic resin material, and combinations thereof.

5. The wiper of claim 3, said bristles having diameters between about 0.0015-0.01 inch.

6. The wiper of claim 1, said wiper comprising two substantially parallel wiper elements and one brush element positioned therebetween.

7. A windshield wiper comprising:
a wiper superstructure operably coupled with a wiper lever;
a resilient wiper element adapted for contacting the surface of a windshield for removing a fluid therefrom;
a brush element spaced from said wiper element and substantially parallel therewith;
a mounting bracket presenting top and bottom surfaces, said top surface presenting an orifice formed therein for receiving one end of said lever;
a plurality of claws extending outwardly from said bottom surface cooperatively forming a plurality of channels through which said wiper and brush elements are slidably received.

8. The wiper of claim 7, said resilient wiper element being comprised of rubber.

9. The wiper of claim 7, said brush element comprising a spine and bristles attached to said spine.

10. The wiper of claim 9, said bristles comprising a material selected from the group consisting of horsehair, hog bristle, synthetic resin materials, and combinations thereof.

11. The wiper of claim 9, said bristles having diameters between about 0.0015-0.01 inch.

12. The wiper of claim 7, said wiper comprising two substantially parallel wiper elements and one brush element positioned therebetween.

13. A windshield wiper comprising:
a cartridge presenting top and bottom cartridge surfaces, said cartridge including at least one resilient wiper element and a brush element spaced from said wiper element and substantially parallel thereto,
said cartridge having a plurality of slots formed therein, said slots extending from said cartridge top surface through said cartridge bottom surface;
a mounting bracket presenting top and bottom bracket surfaces; and
a plurality of flanges extending outwardly from said bracket bottom surface, said flanges adapted for placement into said slots for coupling said bracket with said cartridge.

14. The wiper of claim 13, said resilient wiper element being comprised of rubber.

15. The wiper of claim 13, said brush element comprising a spine and bristles attached to said spine.

16. The wiper of claim 15, said bristles comprising a material selected from the group consisting horsehair, hog bristle, synthetic resin materials, and combinations thereof.

17. The wiper of claim 15, said bristles having diameters between about 0.0015-0.01 inch.

18. The wiper of claim 13, said cartridge comprising two substantially parallel wiper elements and one brush element positioned therebetween.
